(19) United States
(12) Patent Application Publication
(10) Pub. No.: US 2007/0174146 A1
(43) Pub. Date: Jul. 26, 2007

(54) Hierarchical stock allocation system and method

(76) Inventors: Noam Tamarkin, Herzliya (IL); Adi Chibel, Ramat-Gan (IL); Roni Avni, Petach Tiqva (IL); Arieh Shimron, Even-Yehuda (IL)

Correspondence Address: FISH & RICHARDSON, P.C., PO BOX 1022, MINNEAPOLIS, MN, 55440-1022, US

(21) Appl. No.: 11/321,323

(22) Filed: Dec. 29, 2005

(51) Int. Cl. G06Q 10/00

(52) U.S. Cl. 705/28

(57) ABSTRACT

For enterprises having more than one location for their stock inventory, expressing the inventory according to a hierarchical tree of stock locations within the enterprise may allow increased flexibility, planning, and management of stock actions. The method described in this document may allow stock to be ordered, moved, replenished, or allocated at any level on the location hierarchy, and may provide an efficient, dynamic process by which enterprise stock may be measured and acted upon. In a first general aspect, a method comprises a computer-implemented method carried out in performing a stock storage location allocation process. The method comprises receiving, at a computer system, a stock action order including a stock location allocation at a level within a hierarchy of stock locations. At least one level from the hierarchy of stock locations is selected, and a determination is made as to whether the proposed stock location allocation violates an availability of prior stock location allocations at the selected level or levels, by taking into account stock location allocations for at least one level of the hierarchy of stock locations. Information is generated indicating whether the proposed stock allocation violates the availability of prior stock allocations.

### TECHNICAL FIELD

This invention relates to managing stock using a hierarchical stock location description, and more particularly to stock allocation and availability.

### BACKGROUND

Balancing product supply and demand in an enterprise may be paramount to the success of the enterprise. Products, or stock, may be kept within a holding area, such as a warehouse, until such time that an order may be received by the enterprise to effect some action on the stock, such as shipping to a customer. Stock items may be classified according to different types of identifiers, such as a product identifier (ID), product name, or other features which distinguishes that product from the rest of the inventory. Stock items may be acted upon by, for example, a manager requesting that a given quantity of stock from a given location be transported to a shipping area. The stock quantity that is to be shipped may be subtracted from the total stock quantity from the location in which it originated, and from the overall inventory.

Enterprises may utilize inventory computer software solutions to manage stock for supply and demand considerations. Typically, stock may be identified and by a single characterizing attribute such as a product ID which may be kept in a data repository and accessed by an inventory software solution when that stock is to be acted upon. In addition, the stock item may include a location identifier that describes its whereabouts within the enterprise. These two data attributes, the stock identifier, and the stock location, may be the only variables used by software solutions to effect the management of stock across an enterprise.

### SUMMARY

For enterprises having more than one location for their stock inventory, expressing the inventory according to a hierarchical tree of stock locations within the enterprise may allow increased flexibility, planning, and management of stock actions. The method described in this document may allow stock to be ordered, moved, replenished, or allocated at any level on the location hierarchy, and may provide an efficient, dynamic process by which enterprise stock may be measured and acted upon. In a first general aspect, a method comprises a computer-implemented method carried out in performing a stock storage location allocation process. The method comprises receiving, at a computer system, a stock action order including a stock location allocation at a level within a hierarchy of stock locations. At least one level from the hierarchy of stock locations is selected, and a determination is made as to whether the proposed stock location allocation violates an availability of prior stock location allocations at the selected level or levels, by taking into account stock location allocations for at least one level of the hierarchy of stock locations. Information is generated indicating whether the proposed stock allocation violates the availability of prior stock allocations.

In a second general aspect, a method comprises a computer-implemented method for viewing the existing status, or forecasting the future status, of inventory on an enterprise location hierarchy. The method comprises receiving stock inventory information on a location hierarchy, determining time-dependent supply and demand information on a stock within a logistics environment, and generating information for presenting a representation of the existing or forecasted status of stock at each level of an enterprise location hierarchy.

In selected embodiments, the stock action order may include one or both of an order to put specified stock in the proposed stock location and an order to take specified stock from the proposed stock location, wherein the stock action order is an order selected from the group consisting of allocations, queries or checks for planning operations, future allocations, internal stock movements, replenishments, and feasibility checks.

In other selected embodiments, the allocation of stock is based on stock physically located at one of the location levels, or stock anticipated to arrive at one of the location levels. In other selected embodiments, stock information from location levels is used to determine the time until the stock is physically exhausted, the determination taking into account physical, allocated, and anticipated stock actions. In other selected embodiments, the allocation and availability of stock is represented by abstracted representations of stock, such as a logistic unit or handling unit

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram comprising entities within an enterprise.

FIG. 2 is a flow diagram comprising steps to execute features of the invention.

FIG. 3 is a diagram representing location levels and associated stock within an enterprise.

FIG. 4 is a diagram representing location levels and associated stock within an enterprise.

FIG. 5 illustrates features of the invention.

FIG. 6 is a block diagram of an enterprise computing system.

Like reference symbols in the various drawings indicate like elements.

### DETAILED DESCRIPTION

Effective management of the supply and demand for enterprise stock may be central to an enterprise's success. Oftentimes, the inventory of enterprise stock, which may be, for example, goods, assets, or commodities, may be comprised of large databases of stock identifiers which may be used by enterprise software solutions to move, track, and process orders. Stock management, therefore, may be cumbersome when executing orders from multiple locations carrying stock, such as warehouses, aisles, or bins, where stock may be spread among these locations. A method of managing stock according to a predefined hierarchy of stock locations may allow an enterprise inventory system the freedom to perform common stock activities, such as allocating stock, on higher levels than strictly at the stock identifier level.

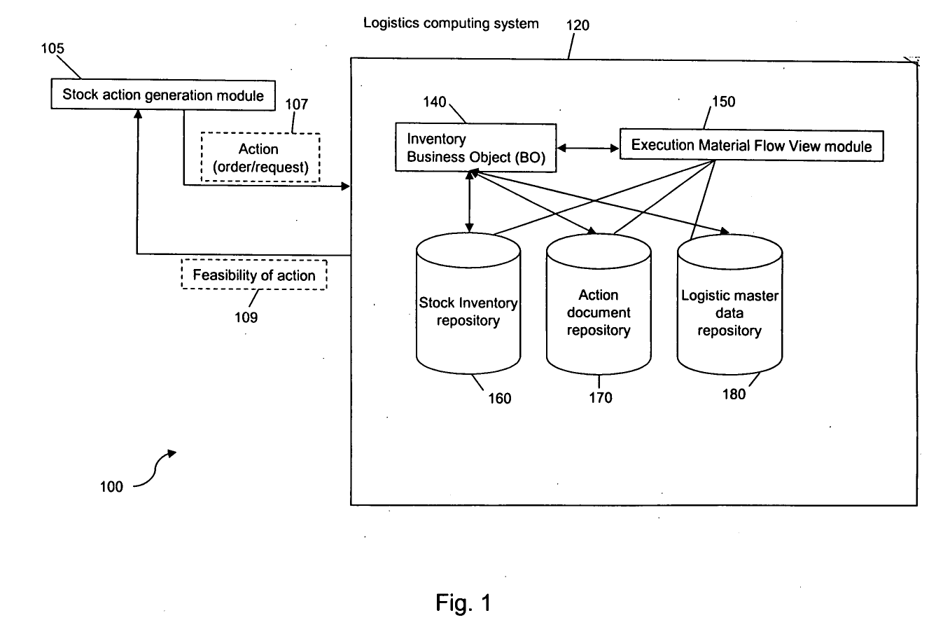

FIG. 1 is a block diagram of an enterprise system 100 that may include entities that may be necessary to perform enterprise stock actions. Stock actions may be, for example, purchase orders for a quantity of stock, requests to move stock, supply shipment orders, or queries for the current state of the stock inventory. In general, the system 100 may receive stock action items (such as orders, or allocations), wherein the associated stock location may be characterized by a location defined on a hierarchical tree representing the storage methods of the enterprise, and may process the action item using predefined rules for stock allocation on the hierarchical storage location tree.

The system 100 may include a stock action module 105 which represents modalities of introducing stock action items into the system 100. Modalities may include electronically-generated or electronically-received stock action orders, or may be the result of human input into the system to effect a given stock action, for example. The system 100 may also include a logistics computing system 120 that may contain computer hardware and software systems to execute commands relating to the management of enterprise stock inventory. Stock actions 107, which may be orders or requests, may be introduced into the logistics computing system 120 via the stock action generation module 105, and the logistics computing system 120 may return a “feasibility of action” indication 109 that may indicate whether or not the stock action 107 may be successfully executed based on current or anticipated stock inventory.

The logistics computing system 120 may include software modules 140, 150, which may write data to, or read data from stock inventory repositories 160, action document repositories 170, and master data repositories 180. The Inventory business object (BO) 140 may be comprised of software execution instructions that allow an enterprise to manage its stock inventory, from, for example, balancing supply and demand, to generating and receiving orders for stock and the associated movement of stock based on the logistics environment. A logistics environment may be an enterprise environment, for example a warehouse, where logistical processes take place, such as storing, shipping, moving, or receiving stock.

An Execution Material Flow View (EMFV) module 150 may execute software instructions to provide an enterprise the ability to view the current status of stock inventory, including the results of anticipated stock actions. The EMFV module 150 may be used to display and analyze time-dependent supply and demand information on stock in various levels of the location hierarchy. The EMFV module 150 may support availability requests based on inventory availability and may manage and support time dimensions, data from site logistics orders and requests, production orders and requests, and master data from business objects such as Material BO, Logistics layout BO, and Batch BO. The EMFV module 150 may not retain independent data, but may consolidate information from other existing BO data, and may use these data to provide aggregated inventory information.

Functionality of the EMFV module 150 may include supply versus demand reports based on enterprise data from the Inventory BO, physical stock and allocations of stock, data from the stock action generation module 105, and order documents BO's (Site logistics Requests/Orders and Production Requests/Orders). In addition, the EMFV module 150 may read data from Logistics Area BO, and Batch BO. Output of EMFV module 150 reports may include: aggregated reports and queries based on inventory and documents (e.g., delivery, shipping, purchase order, sales order, contracts), and Location layout grouping (e.g., aisle, warehouse, storage area, yard), time-line progress of current and anticipated stock, and results of calculations of availability based on current stock and anticipated stock at a given time. The EMFV module 150 may also calculate days of supply remaining for a stock item based on the information collected from the aforementioned BO's, and propose “dynamic pegging” candidates. Dynamic pegging may include allocating excess of stock from one order to fulfill the requirements of a future order that may be deficient in stock quantity.

The stock inventory repository 160 may store detailed information about stock in a logistics environment, including, but not limited to, a stock identification (ID) number, a global trade identification number (GTIN), the date of delivery, its location within the enterprise, and any stock-separator attributes. An example of a stock separator attribute may be the expiration date on cartons of milk for a particular milk shipment; while all milk may be stored in the same location within a warehouse, for example, the milk with the closest match between the current date and the expiration date may be shipped sooner than that with a later expiration date. The action document repository 170 may contain data comprising action orders of the enterprise.

The logistic master data repository 180 may contain detailed enterprise information relating to the hierarchy of locations within the enterprise. The hierarchy of locations may represent a level system, wherein the most abstract, least-resolved description of the location of stock may exist as the top-level, and the highest-resolution description of the location of stock may exist at the bottom of the level system. For example, an enterprise may ship and receive milk as its primary business function. A hierarchy of locations for this enterprise may start at the bottom with location descriptors such as “pallet” to describe the physical location of a particular stock of milk. The next highest level may be “storage bin” to describe the bin that the pallet resides in. In a progression of higher levels, the milk may be described as residing in an aisle, work area, warehouse, plant, city, state, and country. In this instance, the location description “country” would serve as the highest-level, most abstract descriptor of the milk location, while “pallet” may describe the most specific, high-resolution location and may be at the bottom of the location hierarchy. Levels within the hierarchy may have “branches” comprising the same or similar location attributes, but with different descriptors. For example, an “aisle” hierarchical level may have several “shelf” locations (e.g., “top shelf” “middle shelf” “bottom shelf”) that exist on the same level, but they represent physically different locations even though they describe stock locations at the same level of resolution.

The hierarchy of enterprise locations may be populated with stock quantities by the Inventory BO 140, which may utilize stock information from the stock inventory repository 160 and the action document repository 170. The hierarchical structure of a particular enterprise may be contained in master data 180 which may use any resolution of logistics environment levels to satisfy the inventory management needs of the enterprise.

In one embodiment, a stock-populated hierarchal tree exists for a given enterprise, wherein the stock quantities may have been extracted from the stock inventory repository 160 and the structure of the hierarchal tree may be defined in master data 180. Within the hierarchy, stock may be represented by quantity at a given resolution within the levels of the logistics environment. An action 107 may be transmitted by the stock action generation module 105 to the logistics computing system 120 to ship a quantity of stock “X” to a customer. The Inventory BO 140 may receive the action 107 and begin executing software instructions to check the availability of stock X against the hierarchal tree of inventory data. The action 107 may include the location from which the stock is to be taken; in this case, the Inventory BO 140 may check the quantity of stock X at that location. However, it may be the case that previously a warehouse manager pre-allocated all of stock X for an important customer, and has done so by allocating all of the stock X in a particular warehouse for the customer. The Inventory BO 140 may begin an inventory check, progressing up the hierarchical inventory tree, and may not find a problem when checking the action order 107 against the bin, aisle, or area level of the location hierarchy. However, when checking the action order 107 against the “warehouse” level, it may now find that all of stock X has been pre-allocated. In this case, the Inventory BO 140 may return a feasibility of action 109 to the stock action generation module 105 indicating that the order may violate availability rules of the enterprise.

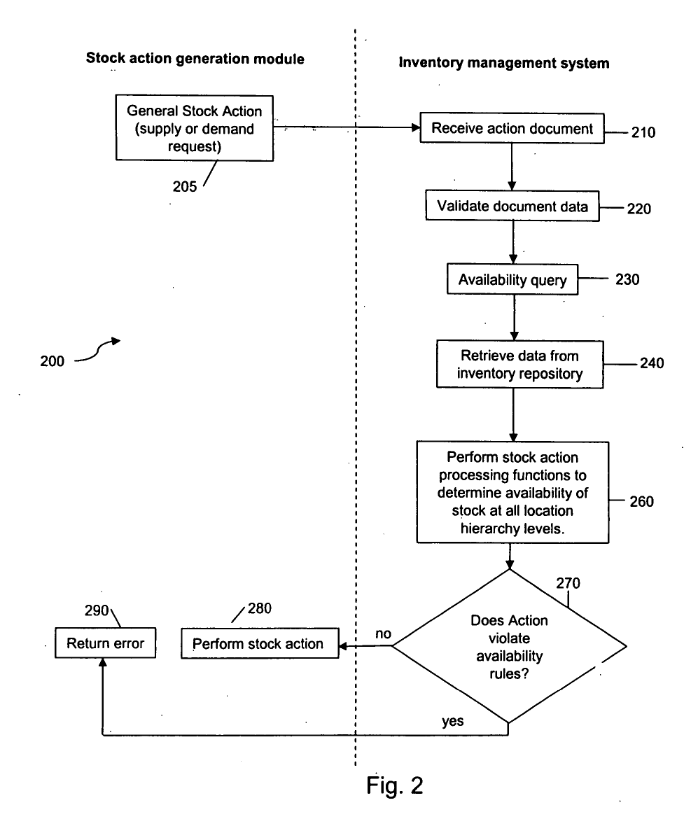

FIG. 2 is a flow diagram 200 of the events that may occur to effect stock management using a hierarchal level system that may contain enterprise stock quantities on predefined levels. The flow diagram 200 is broken into two categories, representing the functions that may occur from the stock action generation module 105, and the Inventory BO 140. First, at step 205, the system receives a stock action which may be a supply or demand request for stock, for example. The stock action may be passed to the Inventory BO at step 210, where the stock action data (which in this case may be a document, such as a purchase order) may be validated at step 220. Validation may include such actions as syntax checking, order completeness, or other verifications to ensure that the document may be processed in such a way that the Inventory BO 140 may properly execute the action. At step 320, an availability query may be performed to check the stock order against the enterprise's inventory. The query may begin at step 240, wherein data may be retrieved from the inventory repository regarding the current level of stock available at the hierarchical levels on which the stock resides. Next, at step 260, this data may be processed according to rules defined by the enterprise which may provide various functions related to the comparison of requested stock, and available stock, for example. In one case, an enterprise may not allow stock to be processed according to the stock action if the quantity of stock in the inventory is less than that requested by the action. However, in another case, the enterprise may wish to allocate all of the current stock requested by the action, even if it may not completely fulfill the action request, delaying the order until the stock can be replenished; similarly, the enterprise may choose to process a partial shipment of stock. These are two examples of rules that may be integrated into the Inventory BO 140.

The stock action may be checked at all levels of the logistical hierarchy locations prior to returning a result. At step 270, the Inventory BO 140 may process the results of the rules calculations in step 260 and may generate an output based on these results. If the action does not violate the availability rules, the Inventory BO 140 may execute the action order; if there is a violation of availability rules, the Inventory BO may return an error at step 290 which may be interpreted or acted upon by the stock action generation module An example returned error may be a message issued to the generator of the stock action explaining that the requested stock action may not be feasible based on the current state of stock, which may include physical stock (stock that may be physically located and available at a location), allocated stock (stock that may be at a location, but has been pre-allocated for another action order) or anticipated stock (stock that may be anticipated to arrive but may not be on site yet).

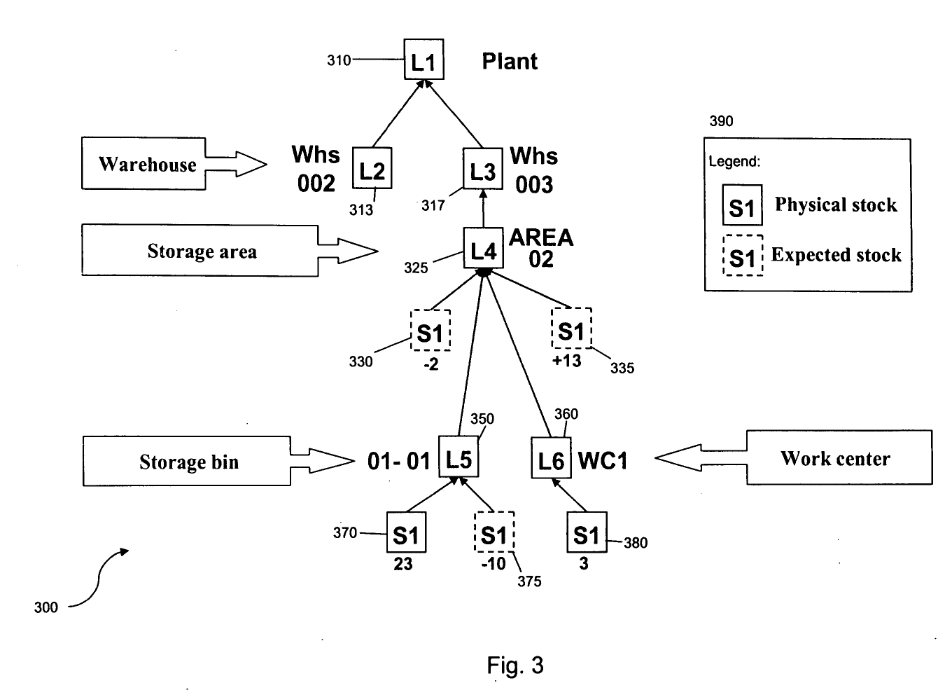

FIG. 3 is an exemplary enterprise location hierarchy 300, comprising several levels of locations and shows stock which may be managed at various levels. The enterprise location hierarchy may have, at its top, a “plant” location 310, indicated as L1. The plant may be comprised of two warehouses “Whs002” and “Whs003,” which are represented on the L2 and L3 levels (313 and 317 respectively), and within Whs003 there may exist a physically defined stock repository “Area02” that may be designated on the L4 level 325. The two lowest levels may define the highest resolution location descriptor for the enterprise stock inventory system, levels L5 and L6 (350 and 360 respectively), which reside on the bottom of the hierarchy and represent a storage bin “01-01” and a work center “WC1” respectively. Stock, “S1” 390, may be stock of any type. The stock which may be residing in a storage location and has not been allocated for any other reason (“Physical stock”) is shown as S1 surrounded by a black box, whereas stock S1 which may not be in a predefined location is shown as S1 surrounded by a dashed box according to the legend 390.

Allocation of stock may be performed on any appropriate level within the hierarchy. For example, a manager may realize that 23 units of stock S1 (370) exist in storage bin 01-01 on L5 (350), and may decide to allocate 10 units of S1 from that level 375 for a particular shipment. The allocation of 10 units of S1 stock from L5 (350) may result in a net 13 units of S1 at L5 (350). In a similar fashion, a delivery order may be received by the system 100 in which 13 units of S1 (335) may be allocated at the “Storage area” level L4 (325), and at the same time, an order may be pending for two units of S1 (330) from the same area 325. In this case, the balance between supply and demand results in 11 units of S1 at area L4 (325). The pending order to remove stock from L4 (325), two units of S1 (330), may be in the form of a pre-allocation (i.e., the order may not be shipped for a period of time), or, the stock 330 may be slated to be moved to another physical location within the logistics environment, for example. Stock allocations may be performed in this manner for any of the levels of the hierarchy.

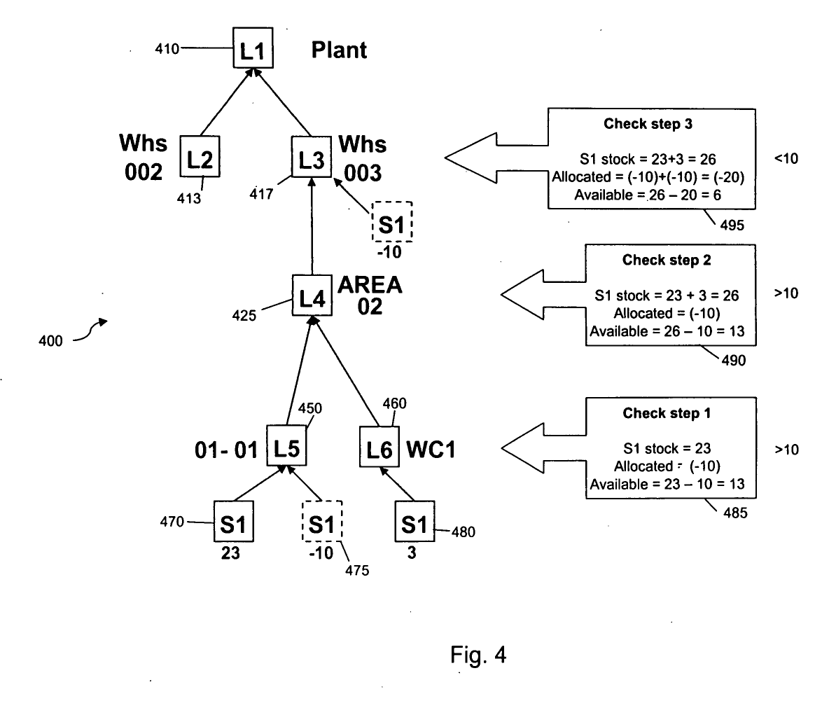

FIG. 4 is an exemplary location hierarchy tree 400 similar to FIG. 3, which may illustrate the availability logic employed by the Inventory BO 140 when determining whether or not a stock action may be successfully executed. The location hierarchy tree 400 includes the same locations as in FIG. 3 (300), and uses the stock legend of FIG. 3 (390) to indicate physical and expected stock. For this example, a stock action order may have been received by the system 100 wherein a request for 10 pieces of stock S1 from location L5 (450) is included. The Inventory BO 140 may utilize software execution instructions to begin an availability check on all levels of the location hierarchy to ensure that the action order request may be successfully fulfilled without violating predefined availability rules. For this example, the availability rule may simply be that an order may not execute a request for more stock than may be physically available from the enterprise inventory.

The availability checking process may begin with availability checks at levels L5 (450), L4 (425), L3 (417), and L1 (410) in order to check that there are no other allocations of S1 in higher levels of the hierarchical tree that allocated other units of S1 for other purposes. If the availability check is successful, the allocation may be performed at any appropriate level of the hierarchical tree, while the execution of the stock action order may be performed at the bin level 450. If the availability check fails, an indication may be made to the user (e.g., in the form of an error message) that the proposed allocation will not be possible given the current state of the inventory (present and anticipated). During the first check 485 at the L5 (450) level, the quantity of S1 stock available is 23 (470), but contains an allocation of 10 units of S1 (475) for a net availability of 13 units. Since 13 is greater than 10, the availability rules are satisfied. In the next checking step 490, the stock inventory may be checked at the “area” level 425, which includes the two levels below, L5 (450) and L6 (460). At the L4 level 425, the quantity of available stock S1 is 26 (23 units from L5 (450) and 3 units from L6 (460)), and includes the pre-allocated 10 units from L5 (450), for a net availability of 13 units. Again, the availability rule may be satisfied. The check 495 for S1 availability at the “warehouse” level L3 (417) indicates that the available stock S1 is again 26, however, an allocation for stock S1 has been made at the L3 level 417 for 10 units. At this level, the net available stock S1 is 26 minus 20 (10 units allocated from L5, 10 units allocated from L3) which equals 6 units of available stock S1. Since 6 is less than 10, a violation of the availability rules has occurred and the Inventory BO 140 may now generate a feasibility of action 190 report that may indicate a problem with fulfilling the action order request.

The preceding example executed checking steps 485, 490, 495 in ascending order through the hierarchical location tree, however the checking steps may be performed in descending order if necessary. An example for this method of checking sequence may be as follows. A manager of a warehouse may have an inventory situation as described in FIG. 4, where there may be 26 total units of S1 stock with 20 units of S1 slated for outgoing orders. A president of the enterprise may decide that they want all S1 stock from all plants comprising the enterprise to be moved to a new storage facility that may be currently empty. The president may enter a stock action order to allocate all S1 stock at the L1 level 410 to the new storage facility. Upon doing so, the Inventory BO 140 may check all the levels of the hierarchical tree below L1, and may find that the manager has pending orders to ship 20 units of S1 to customers. Depending on the availability rules defined for this particular example, the Inventory BO 140 may generate a feasibility of action report 109 that may alert the president that the order to move all S1 stock would effect orders for S1 already in progress at the warehouse level. In this case, a “top-down” availability check may fail, since the manager's allocation would affect the president's proposed allocation (superiority may override the manager's allocation, however, such that the president may allocate stock regardless of allocations made at lower levels, if necessary).

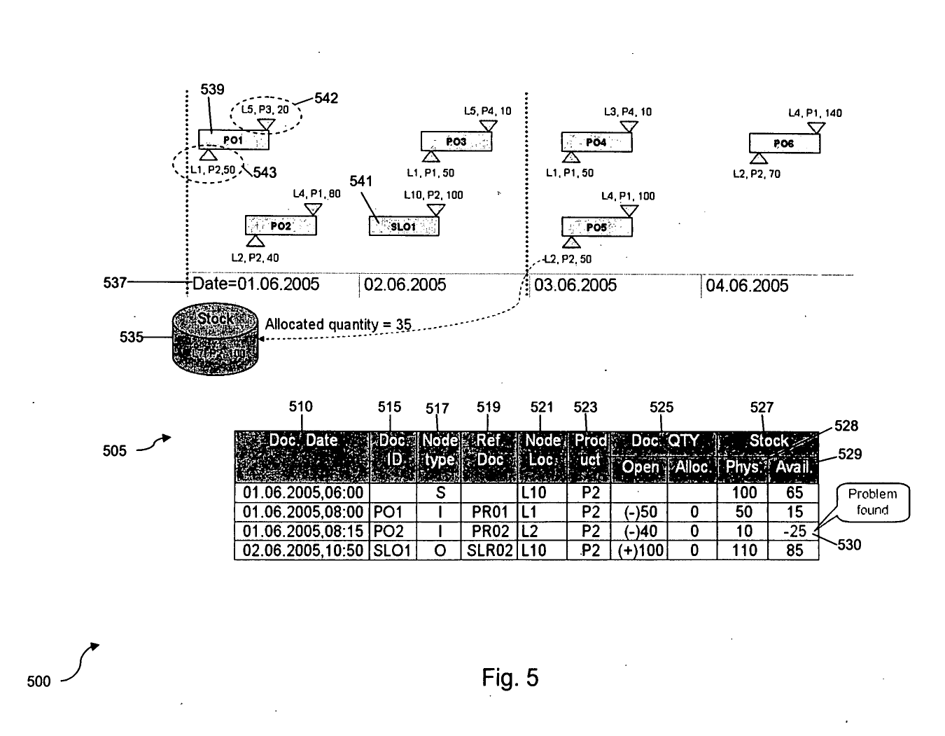

FIG. 5 illustrates further embodiments for the use of stock allocation and availability using a location hierarchy to effect stock management. The system 500 may comprise entities that may be found in an enterprise Inventory BO. A database of stock action items 505 that may be constructed from, for example, an action document repository 170, is shown with database fields that may describe the action order.

Included in these fields may be the document date 510, document identifier 515, node type 517, reference document 519, node location 521, product 523, document quantity 525, which includes open and allocated stock, and stock 527 that may indicate the physical 528 and available 529 stock. Available stock may be stock that may be anticipated to arrive, but may not yet be in a physically defined location. Above the database of stock items 505 is a timeline of logistic processes that may be represented by the database items 505. The graphical representation of a logistic process 539 in FIG. 5 comprises a labeled box (purchase order (PO), PO1) with upward and downward pointing arrows 543, 542 respectively, that represent incoming or outgoing stock transactions. For example, the process 539, which may be a stock action order, may be a purchase order for 50 units of product (“P2”) from a location (“L1”) 543. Also included in PO1 maybe a return of 20 “P3” units which may represent a different product P3, and the units should be placed in location L5. The two types of stock action documents illustrated in FIG. 5 are purchase orders (PO) and Site Logistic Orders (SLO) 541. An example of a SLO may be a stock replenishment request from a vendor, or an in-house movement of stock. The repository of stock 535 indicates in this situation that there are 100 units of product P2 at location L7.

The system 500 describes a situation in which a manager may wish to view the flow of stock, i.e., supply and demand, for a period of time and use the hierarchical stock location structure to anticipate problems in meeting the supply and demand of the enterprise. The Inventory BO 140 may access documents that reside in the stock inventory repository 160, the action document repository 170, and the master data repository 180 to build a database table 505 similar to that found in FIG. 5, which data correlates to the timeline of stock transactions. The first entry in the database table 505 with a document date 01.06.2005, 06:00, lists 100 units of product “P2” physically located at “L7.” 35 units of P2 have been pre-allocated for PO5, which is scheduled to ship on 03.06.2005, thus, 65 units are available for stock action items on 01.06.2005, 06:00. Stock action PO1 (539), a purchase order for 50 units of P2 from L1 corresponds to the second entry of the database table 505. In this instance, the quantity of requested stock may be listed as a negative value in the Document Quantity column 525, reduces the Physical Stock column 528 by 50 units (from 100), to leave 15 units of P2 stock available for stock action orders. Purchase order 2 (PO2), which is scheduled to execute on 01.06.2005, 08:15:00, may request 40 units of P2 from location L2. The Inventory BO 140 may check the hierarchical level above L2, L1, and find that there are only 15 units of P2 available, even though 10 units are physically located within the logistics environment (the allocation of stock for PO5, which may be for an important customer, precludes the availability for PO2, even though the scheduled execution date for PO2 may be earlier). The resulting feasibility of action report 109 may then alert the system that an availability violation has occurred according to a set of rules that may not allow stock action orders to be executed unless suitable stock exists for the order. SLO1 (541) may be a replenishment order for 100 units of P2, scheduled to arrive on 2.06.2005 at location L10. The system, or a manager, may study the database of scheduled stock action items to realize that there may be a stock inventory problem on 01.06.2005, 08:15, wherein the inventory will be deficient of 25 units of P2. At that point, a decision may be made to change the arrival date of the SLO1 replenishment order such that the inventory may support the requests of PO and PO2.

Allocations may not be limited to stock “items,” and may include “capacity” as a unit for appropriating space for stock. Capacity may be defined in terms of maximum or minimum weight, volume, length, width, or height, or any combination thereof, and may be used to describe stock and logistics locations dimensions. For example, the volume of a bin may have a known volume, and the volume occupied by a certain stock item may similarly be known. In this manner, the number of units of stock that will fit into the bin may be calculated and the allocation of stock may be then performed by allocating stock volume, rather than stock quantity on a particular location hierarchy level. An approach to allocation using capacity may include converting a product (or LU) and location dimensions into a ‘capacity ratio’ (i.e., product/LU dimensions divided by location dimensions). The capacity is the location capacity minus the on-hand stock capacity minus the allocated capacity (if greater than zero, as negative allocation is possible), and would be expressed in absolute terms. Another embodiment of an example calculation of realistic capacity availability may be:
1−((on-hand stock×capacity ratio)+(incoming stock×capacity ratio)), and may be expressed as a percentage of available capacity.

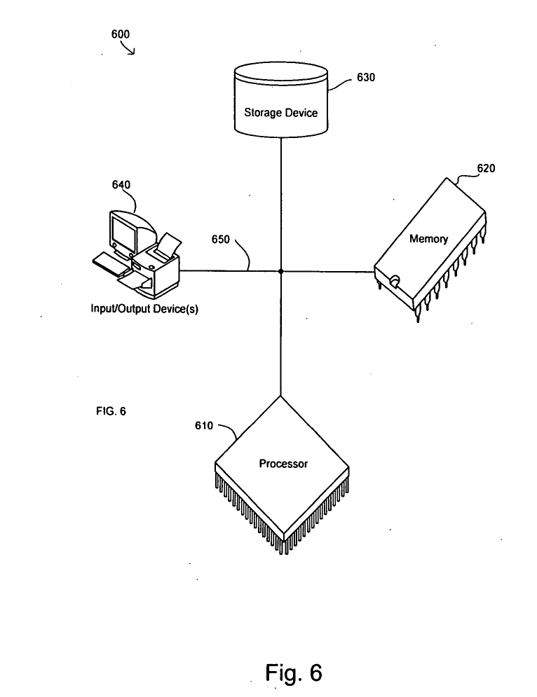

FIG. 6 is a schematic diagram of a generic computer system 600. The system 600 can be used in the methods described above, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 700. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. “Stock” and “locations” need not refer to products and warehouse entities, as it has been used in the above description, and may construe objects, such as people, and locations, such as tables, in a restaurant environment, for example.

Stock may be allocated on a location which belongs to an abstract representation of a group of similar items, for example, a Logistical Operating Unit (LU) or Handling Unit (HU). An example of a LU would be the abstraction “pallets,” which represents all pallets of a certain, predefined type. An example HU would be “pallet Z” to specifically refer to a given pallet. Likewise, the entire LU or HU need not be allocated; portions of the stock on a LU or HU may be allocated.

Allocations may be made with stock separating attributes. An example may be a storage location for cartons of milk. While this location may be defined as a level, the expiration dates for the milk shipments may be used to prioritize which milk may be slated for delivery first or last.

“Batch” may be used as a stock separating attribute, as well as “wildcards” in batch identifiers.

Allocation and availability data may be aggregated into tables to reflect aggregated availability results according to user-defined input.

Quantities from various levels within an enterprise location hierarchy may be “offset” to provide allocations to other levels. For example, an order of 20 units of product P1 from location A was found to violate availability rules. In this case, a manager, or the system, may offset a different storage area B, containing P1, to provide enough product at location A to fulfill the order. Stock may be moved about the enterprise from any level on the hierarchical tree to another.

Stock allocation may be performed in a logistics area that is defined in coordination with the physical site structure.

HU's may be allocated by ID regardless of its content. This “phantom allocation” may reduce or increase the level of stock at a given level on the hierarchical location tree.

Allocations may be typed according to allocation rules, such as “all or nothing,” “over allocation,” or “partial allocation.” An example of an “all or nothing” allocation type would be a customer who will accept only full shipments of product, and no partial shipments.

Availability requests of stock may be performed on specified allocation types, such as “physical” or “anticipated.” A use of this feature may include a manager who wishes to allocated all anticipated deliveries of a certain stock for a large upcoming order.

Accordingly, other embodiments are within the scope of the following claims.

What is claimed is:

1. A computer-implemented method carried out in performing a stock storage location allocation process, the method comprising:
receiving, at a computer system, a stock action order including a stock location allocation at a level within a hierarchy of stock locations;
selecting at least one level from the hierarchy of stock locations, and determining whether the proposed stock location allocation violates an availability of prior stock location allocations at the selected level or levels by taking into account stock location allocations for at least one level of the hierarchy of stock locations; and
generating information indicating whether the proposed stock allocation violates the availability of prior stock allocations.

2. The method of claim 1, further comprising, if the proposed stock allocation is determined to violate the availability of prior stock allocations, determining if a stock action can be taken from a level in the hierarchy such that the proposed stock location allocation would no longer violate the availability of prior stock allocations.

3. The method of claim 1, wherein the stock action order includes one or both of an order to put specified stock in the proposed stock location and an order to take specified stock from the proposed stock location, wherein the stock action order is an order selected from the group consisting of allocations, queries or checks for planning operations, future allocations, internal stock movements, replenishments, and feasibility checks.

4. The method of claim 1, wherein the allocation of stock is based on stock physically located at one of the location levels, or stock anticipated to arrive at one of the location levels.

5. The method of claim 1, further comprising using descriptor wildcards in the allocation step or during an availability check.

6. The method of claim 1, wherein the allocation and availability of stock is represented by abstracted representations of stock, such as a logistic unit or handling unit.

7. The method of claim 1, wherein stock is reserved at a location level so as to be available for specific future stock actions.

8. The method of claim 7, wherein available stock at a location level is pre-allocated to fill requirements of a future stock action at a location level.

9. A computer-implemented method for viewing the existing status, or forecasting the future status, of inventory on an enterprise location hierarchy, the method comprising:
receiving stock inventory information on a location hierarchy;
determining time-dependent supply and demand information on a stock within a logistics environment; and
generating information for presenting a representation of the existing or forecasted status of stock at each level of an enterprise location hierarchy.

10. The method of claim 9, wherein stock information from hierarchical location levels is used to determine the time until the stock is physically exhausted, the determination taking into account physical, allocated, and anticipated stock actions

11. A computer program product comprising executable instructions that, when executed, cause a system to perform the following operations: receiving, at a computer system, a stock action order including a stock location allocation at a level within a hierarchy of stock locations;
determining whether the proposed stock location allocation violates an availability of prior stock location allocations by taking into account stock location allocations for at least one level of the hierarchy of stock locations; and
generating information indicating whether the proposed stock allocation violates the availability of prior stock allocations.

12. The computer program product of claim 11, further comprising, if the proposed stock allocation is determined to violate the availability of prior stock allocations, determining if a stock action can be taken from a level in the hierarchy such that that the proposed stock location allocation would no longer violate the availability of prior stock allocations.

13. The computer program product of claim 11, wherein the stock action order includes one or both of an order to put specified stock in the proposed stock location and an order to take specified stock from the proposed stock location.

14. The computer program product of claim 13, wherein the allocation of stock is based on stock physically located at one of the location levels, or stock anticipated to arrive at one of the location levels.

15. The computer program product of claim 11, further comprising using descriptor wildcards in the allocation step or during an availability check.

16. The computer program product of claim 11 wherein the allocation and availability of stock is represented by abstracted representations of stock, (Logistics Operations Units and Handling Units).

17. The computer program product of claim 11, wherein stock is reserved at a location level so as to be available for specific future stock actions

18. The computer program product of claim 17, wherein available stock at a location level is pre-allocated to fill the requirements of a future stock action at a location level.

19. A computer program product for viewing the existing status, or forecasting the future status, of inventory on an enterprise location hierarchy, the method comprising:
receiving stock inventory information on a location hierarchy;
determining time-dependent supply and demand information on a stock within a logistics environment; and
generating information for presenting a representation of the existing or forecasted status of stock at each level of an enterprise location hierarchy.

20. The method of claim 19, wherein stock information from hierarchical location levels is used to determine the time until the stock is physically exhausted, the determination taking into account physical, allocated, and anticipated stock actions.
